(19) United States
(12) Patent Application Publication
(10) Pub. No.: US 2007/0146937 A1
(43) Pub. Date: Jun. 28, 2007

(54) Recording medium drive including latch member for head actuator member

(75) Inventors: Kazunori Akama, Kawasaki (JP); Yasuhiko Kato, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/373,553

(22) Filed: Mar. 10, 2006

(30) Foreign Application Priority Data
Dec. 28, 2005 (JP) 2005-380329

(51) Int. Cl. G11B 5/54

(52) U.S. Cl. 360/256.4

(57) ABSTRACT

A recording medium drive allows a latch stop member to receive a latch member. The swinging movement around a rotation shaft causes the latch member to enter the movement path of a head actuator member. The latch member thus engages with the head actuator member. The latch member has the portion in contact with the latch stop member. The portion is made of a material different from the main portion of the latch member. The repulsive coefficient can be adjusted between the portion and the latch stop member. An identical condition can be established for transmission of an impact between the head actuator member and the actuator stop member as well as between the latch member and the latch stop member. Even if impacts of different duration act on the recording medium drive, the latch member is allowed to reliably engage with the head actuator member.

### BACKGROUND OF THE INVENTION

1. Field of the Invention

The present invention relates to a recoding medium drive such as a hard disk drive, HDD, for example. In particular, the invention relates to a recording medium drive including a head actuator member designed to swing around a support shaft from an inoperative position, the head actuator member following a predetermined movement path around the support shaft when the head actuator member takes off from a ramp member, and a latch member designed to swing around a rotation shaft from a standby position so as to enter the movement path of the head actuator member.

2. Description of the Prior Art

A hard disk drive includes an enclosure made of aluminum, for example. A head actuator member, namely a carriage, a latch member, and the like, are contained within the enclosure. A head slider is supported on the tip end of the carriage. When the carriage swings from an inoperative position to follow a predetermined movement path around a support shaft, the tip end of the carriage is allowed to get opposed to the surface of a magnetic recording disk. The carriage at the inoperative position keeps contact with a receiving member made of a resin material based on a magnetic force, for example. When an impact acts on the enclosure of the hard disk drive, the impact is transmitted from the receiving member to the carriage. The carriage is thus forced to swing around the support shaft from the inoperative position so as to follow the predetermined movement path.

The latch member is designed to swing around a rotation shaft from a standby position. The latch member at the standby position keeps contact with the inner surface of the enclosure based on a magnetic force, for example. When an impact acts on the enclosure of the hard disk drive, the latch member receives the impact from the enclosure. The impact forces the latch member to move into the aforementioned movement path of the carriage. The latch member is thus allowed to engage with the carriage. The tip end of the carriage is in this manner held on a ramp member outside the magnetic recording disk.

When an impact acts on the enclosure of the hard disk drive, the latch member enters the movement path of the carriage at a predetermined timing. The timing depends on the duration of the impact. Specifically, the duration is set to have a predetermined value in determining the timing. However, the duration of an actual impact in fact changes depending on the material of an object colliding against the enclosure. The change of the duration inevitably induces a failure in engagement of the latch member with the carriage. The carriage is forced to take off from the ramp member. The head slider in this manner contacts with the surface of the magnetic recording disk. The head slider suffers from attachment to the surface of the magnetic recording disk. The magnetic recording disk is prevented from starting rotating.

### SUMMARY OF THE INVENTION

It is accordingly an object of the present invention to provide a recording medium drive capable of reliably engaging with a head actuator member. It is an object of the present invention to provide a latch member greatly contributing to realization of the recording medium drive.

According to a first aspect of the present invention, there is provided a recording medium drive comprising: a head actuator member supported on a support shaft for swinging movement around the support shaft; a latch member supported on a rotation shaft for swinging movement from a standby position around the rotation shaft, the latch member designed to engage with the head actuator member; a latch stop member designed to receive the latch member at the standby position, wherein the latch member has a portion allowed to contact with the latch stop member. The portion is made of a material different from a material of a main portion of the latch member.

The recording medium drive allows the latch stop member to receive the latch member at the standby position. The swinging movement of the latch member around the rotation shaft causes the latch member to enter the movement path of the head actuator member. The latch member thus engages with the head actuator member. The head actuator member is restrained from a further swinging movement. In this case, the latch member has the portion in contact with the latch stop member. The portion is made of a material different from the main portion of the latch member. The repulsive coefficient can be adjusted between the portion and the latch stop member. If the repulsive coefficient between the latch member and the latch stop member is set to coincide with the repulsive coefficient between the head actuator member and an actuator stop member designed to receive the head actuator member, an identical condition can be established for transmission of an impact between the head actuator member and the actuator stop member as well as between the latch member and the latch stop member. Even if impacts of different duration act on the recording medium drive, the timing of the swinging movement of the head actuator member coincides with the timing of the swinging movement of the latch member. The latch member is thus allowed to reliably engage with the head actuator member. If the main portion of the latch member is made of a material identical to that of conventional latch members, the latch member is allowed to have a sufficient function identical to that of the conventional latch members. Composite molding may be utilized to form the portion and the main portion in a one-piece structure.

A specific latch member may be provided to realize the aforementioned recording medium drive. The specific latch member may be designed to swing around a rotation shaft so as to engage with a head actuator member in an enclosure of the recording medium drive. The latch member has a portion allowed to contact with a latch stop member when the latch member takes a standby position. The portion is made of a material different from a material of a main portion of the latch member.

According to a second aspect of the present invention, there is provided a recording medium drive comprising: an enclosure; a head actuator member supported on a support shaft in the enclosure for swinging movement around the support shaft; and a latch member supported on a rotation shaft in the enclosure for swinging movement around the rotation shaft, the latch member designed to engage with the head actuator member, wherein the latch member has a portion located near or in contact with an inner surface of the enclosure, said portion being made of a material different from a material of a main portion of the latch member.

The recording medium drive allows the latch member to contact with the inner surface of the enclosure based on the swinging movement of the latch member around the rotation shaft, for example. The swinging movement of the latch member around the rotation shaft causes the latch member to enter the movement path of the head actuator member. The latch member thus engages with the head actuator member. The head actuator member is restrained from a further swinging movement. The latch member includes a portion allowed to contact with the inner surface of the enclosure. The portion is made of a material different from that of the main portion of the latch member. If the repulsive coefficient between the latch member and the latch stop member is set to coincide with the repulsive coefficient between the head actuator member and an actuator stop member designed to receive the head actuator member in the aforementioned manner, an identical condition can be established for transmission of an impact between the head actuator member and the actuator stop member as well as between the latch member and the latch stop member. Even if impacts of different duration act on the recording medium drive, the timing of the swinging movement of the head actuator member coincides with the timing of the swinging movement of the latch member. The latch member is thus allowed to reliably engage with the head actuator member.

As described above, the latch member includes the portion located near or in contact with the inner surface of the enclosure. The portion is made of a material different from the material of the main portion of the latch member. Here, the portion may be made of an elastic material, for example. This enables reduction in the impact. The enclosure is thus allowed to enjoy reduction in vibration.

A specific latch member may be provided to realize the aforementioned recording medium drive. The specific latch member may be designed to swing around a rotation shaft so as to engage with a head actuator member in an enclosure of the recording medium drive. The latch member has a portion located near or in contact with an inner surface of the enclosure. The portion is made of an elastic material.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a hard disk drive as an example of a recording medium drive according to the present invention;

FIG. 2 is a plan view schematically illustrating the inner structure of the hard disk drive;

FIG. 3 is an enlarged partial plan view of the hard disk drive;

FIG. 4 is an enlarged partial sectional view of the hard disk drive for schematically illustrating the structure of a latch member;

FIG. 5 is a plan view of the hard disk drive for schematically illustrating the engagement of the latch member with a carriage or head actuator member;

FIG. 6 is a graph showing the relationship between the duration of impact and the angles of rotation of the latch member and the head actuator member according to an embodiment of the present invention;

FIG. 7 is a graph showing the relationship between the duration of impact and the angles of rotation of the latch member and the head actuator member according to a comparative example;

FIG. 8 is a graph showing the acceleration of the cover upon application of an impact according to a second sample;

FIG. 9 is a graph showing the acceleration of the cover upon application of an impact according to a first sample;

FIG. 10 is a graph showing the acceleration of the cover upon application of an impact according to the second sample; and

FIG. 11 is a graph showing the acceleration of the cover upon application of an impact according to the first sample.

### DESCRIPTION OF THE PREFERRED EMBODIMENT

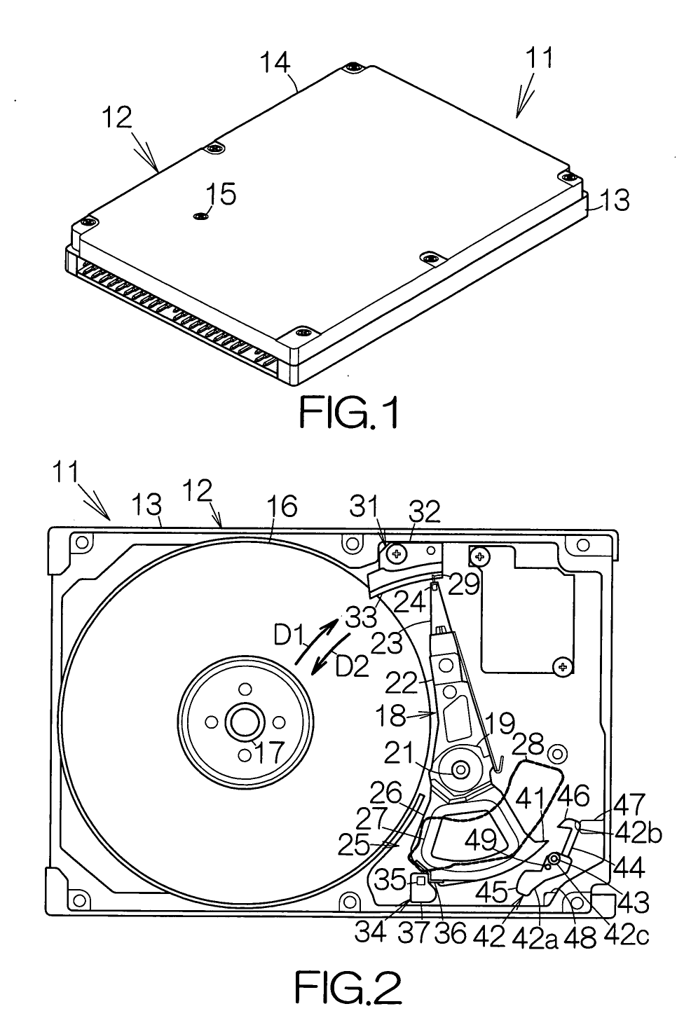

FIG. 1 schematically illustrates the inner structure of a hard disk drive, HDD, 11 as a specific example of a recoding medium drive according to an embodiment of the present invention. The hard disk drive 11 includes a box-shaped enclosure 12. The enclosure 12 includes a box-shaped base 13 defining an inner space of a flat parallelepiped opened upward, for example. The base 13 may be made of a metallic material such as aluminum, for example. Molding process may be employed to form the base 13.

A cover 14 is coupled to the base 13. The cover 14 serves to close the opening of the base 13. Pressing process may be employed to form the cover out of a plate, for example. An aluminum plate may be employed as the plate, for example. A screw 15 is screwed into the cover 14. The screw 15 is received at a support shaft for a head actuator member as described later in detail.

As shown in FIG. 2, at least one magnetic recording disk 16 as a recording medium is incorporated within the inner space of the base 13. The magnetic recording disk or disks 16 are mounted on the driving shaft of a spindle motor 17. The spindle motor 17 drives the magnetic recording disk or disks 16 at a higher revolution speed such as 5,400 rpm, 7,200 rpm, 10,000 rpm, 15,000 rpm, or the like.

A head actuator member, namely a carriage 18 is also incorporated within the inner space of the base 13. The carriage 18 includes a carriage block 19. The carriage block 19 is supported on a vertical support shaft 21 for relative rotation. A screw, not shown, may be employed to fix the support shaft 21 to the base 13, for example. The aforementioned screw 15 serves to couple the cover 14 with the support shaft 21. Carriage arms 22 are defined in the carriage block 19. The carriage arms 22 are designed to extend in the horizontal direction from the support shaft 21. The carriage block 19 may be made of aluminum, for example. Extrusion molding process may be employed to form the carriage block 19.

An elastic head suspension 23 is fixed to the tip end of the individual carriage arm 22. The head suspension 23 is designed to extend forward from the tip end of the carriage arm 22. A gimbal spring, not shown, is connected to the tip end of the individual head suspension 23. A flying head slider 24 is fixed to the surface of the gimbal spring. The gimbal spring allows the flying head slider 24 to change its attitude relative to the head suspension 23.

An electromagnetic transducer, not shown, is mounted on the flying head slider 24. The electromagnetic transducer may include a write element and a read element. The write element may include a thin film magnetic head designed to write magnetic information data into the magnetic recording disk 16 by utilizing a magnetic field induced at a thin film coil pattern. The read element may include a giant magnetoresistive (GMR) element or a tunnel-junction magnetoresistive (TMR) element designed to discriminate magnetic information data on the magnetic recording disk 16 by utilizing variation in the electric resistance of a spin valve film or a tunnel-junction film, for example.

When the magnetic recording disk 16 rotates, the flying head slider 24 is allowed to receive an airflow generated along the rotating magnetic recording disk 16. The airflow serves to generate a positive pressure or a lift as well as a negative pressure on the flying head slider 24. The flying head slider 24 is thus allowed to keep flying above the surface of the magnetic recording disk 16 during the rotation of the magnetic recording disk 16 at a higher stability established by the balance between the urging force of the head suspension 23 and the combination of the lift and the negative pressure.

When the carriage 18 is driven to swing around the support shaft 21 during the flight of the flying head slider 24, the flying head slider 24 is allowed to move in the radial direction of the magnetic recording disk 16. The electromagnetic transducer on the flying head slider 24 is thus allowed to cross the data zone defined between innermost and outermost recording tracks. The electromagnetic transducer can thus be positioned right above a target recording track on the magnetic recording disk 16.

A voice coil motor, VCM, 25 is connected to the carriage block 19. A support body 26 is formed integral with the carriage block 19. The support body 26 is designed to extend in the horizontal direction from the support shaft 21. A coil 27 of the voice coil motor 25 is wound around the support body 26. The support body 26 is opposed to a permanent magnet 28 fixed to the base 13. When a magnetic field is induced in the coil 27 in response to the supply of electric current, the carriage 18 is driven to swing.

A load member, namely a load tab 29, is attached to the front or tip end of the head suspension 23. The load tab 29 is designed to extend forward from the head suspension 23. The load tab 29 is allowed to move in the radial direction of the magnetic recording disk 16 based on the swinging movement of the carriage 18. A ramp member 31 is located outside the magnetic recording disk 16 on the movement path of the load tab 29. The load tab 29 is received on the ramp member 31.

The ramp member 31 includes an attachment base 32 fixed to the base 13 outside the magnetic recording disk 16. The attachment base 32 may be screwed in the bottom plate of the base 13. The ramp member 28 also includes ramps 33 extending from the attachment base 32 toward the vertical support shaft 21 of the carriage 18 in the horizontal direction. The ramps 33 are formed integral to the attachment base 32 based on molding process, for example. The tip end of the ramp 33 is opposed to a non-data zone outside the outermost recording track on the magnetic recording disk 16. The ramp member 31 and the load tabs 29 in combination establish a so-called load/unload mechanism. The ramp member 31 may be made of a hard plastic material, for example.

A retention mechanism 34 is related to the carriage 18. The retention mechanism 34 includes a permanent magnet 35 fixed to the base 13 and a magnetic piece or metallic piece 36 opposed to the permanent magnet 35. The permanent magnet 33 is embedded in an actuator stop member 37 fixed to the base 13. The actuator stop member 37 may be made of an elastic resin material such as rubber, for example. The metallic piece 36 is attached to an end of the support body 26. An iron ball may be employed as the metallic piece 36, for example. The metallic piece 36 is subjected to the magnetic attraction of the permanent magnet 35. The magnetic attraction of the permanent magnet 35 serves to keep the support body 26 of the carriage 18 in contact with the actuator stop member 37.

As is apparent from FIG. 2, when the carriage 18 swings farthest in a normal direction Dl outward the magnetic recording disk 16, the metallic piece 36 is received on the actuator stop member 37. The load tabs 29 are received on the ramp member 31. The carriage 18 in this manner reaches an inoperative position. On the other hand, when the carriage 18 swings from the inoperative position in the reverse direction D2 opposite to the normal direction D1, the load tabs 29 take off from the ramp member 31.

A protuberance 41 is formed in the support body 26 of the carriage 18. The protuberance 41 is designed to extend along an imaginary arc concentric to the longitudinal axis of the support shaft 21. The protuberance 41 may be formed integral with the support body 26. The protuberance 41 moves along a predetermined movement path on the imaginary arc during the swinging movement of the carriage 18.

A latch member 42 is related to the protuberance 41. The latch member 42 is supported on a rotation shaft 43 for relative rotation. The rotation shaft 43 is designed to stand upright from the base 13. As shown in FIG. 3, the latch member 42 includes a first swinging piece 44 and a second swinging piece 45. The first and second swinging pieces 44, 45 are designed to extend in the opposite direction from the rotation shaft 43 in the horizontal direction. The first and second swinging pieces 44, 45 are integral to each other. A hook 46 is defined in the tip end of the first swinging piece 44.

A first latch stop member 47 is located on the base 13. The first latch stop member 47 may be integral to the base 13, for example. The first latch stop member 47 is positioned within the movement path of the first swinging piece 44 of the latch member 42 around the rotation axis 43. The first latch stop member 47 is designed to receive the first swinging piece 44 swinging in a first direction FD. The contact of the first latch stop member 47 in this manner serves to establish a standby position of the latch member 42. When the latch member 42 takes the standby position, the hook 46 of the first swinging piece 44 gets out of the movement path of the protuberance 41.

A second latch stop member 48 is likewise located on the base 13. The second latch stop member 48 may be integral to the base 13, for example. The second latch stop member 48 is positioned within the movement path of the second swinging piece 45 of the latch member 42 around the rotation axis 43. The second latch stop member 48 is designed to receive the second swinging piece 45 so as to restrain the swinging movement of the first swinging piece 44 in a second direction SD opposite to the first direction FD. The contact of the second latch stop member 48 in this manner serves to establish an operative position of the latch member 42. When the latch member 42 takes the operative position, the hook 46 of the first swinging piece 44 enters the movement path of the protuberance 41.

A magnetic piece 49 is located on the second swinging piece 45. A iron ball may be utilized as the magnetic piece 49, for example. The magnetic piece 49 may be embedded in the second swinging piece 45. The magnetic piece 49 is subjected to the magnetic attraction from a yoke of the voice coil motor 25.

The latch member 42 includes a main portion 42a and a first specific portion 42b. The first specific portion 42b is made of a material different from the material of the main portion 42a. The latch member 42 allows the first specific portion 42b to contact with the first latch stop member 47. The main portion 42a of the latch member 42 is made of a high strength resin such as polyacetal (POM), polyether sulfone (PES), polycarbonate (PC), or the like, for example. The first specific portion 42b may be made of an elastic resin material such as rubber. The first specific portion 42b may be joined to the main portion 42a. Composite molding may be employed to form the main portion 42a and the first specific portion 42b in a one-piece structure.

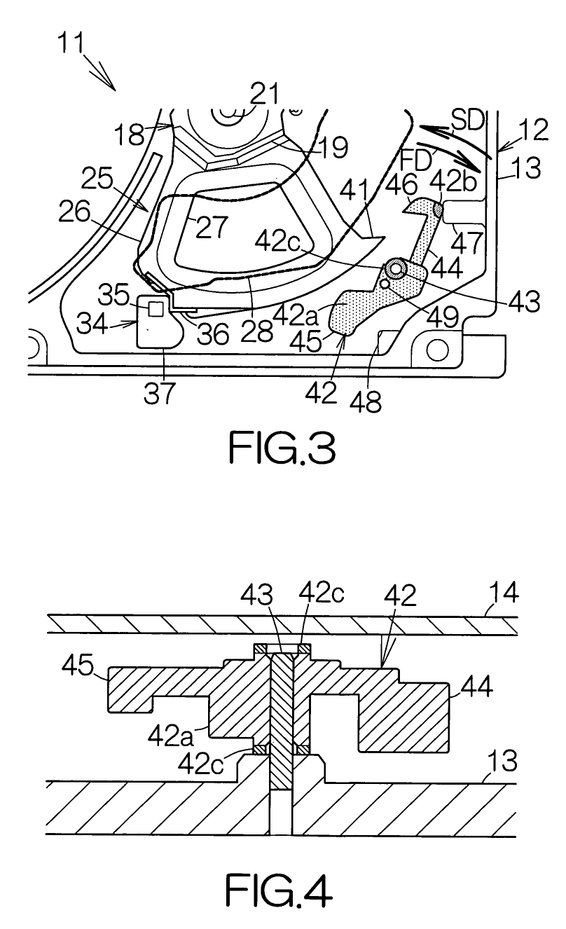

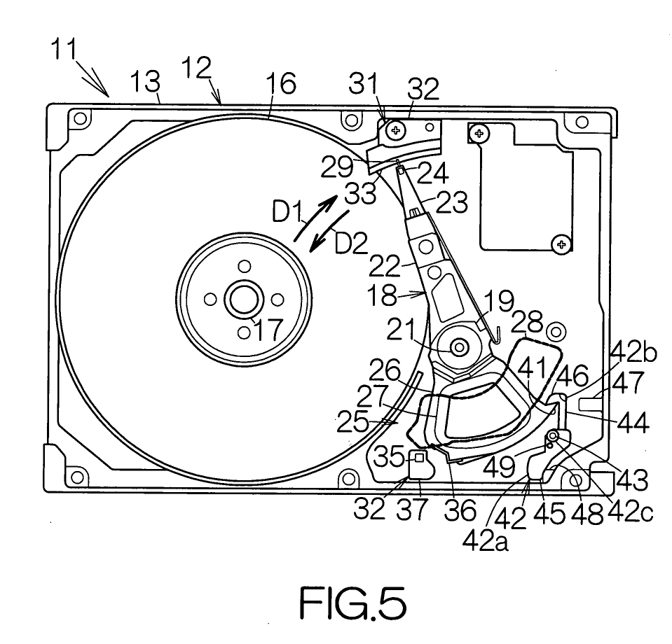

The latch member 42 also includes a second specific portion 42c. The second specific portion 42c is made of a material different from the material of the main portion 42a. Here, the second specific portion 42c is established around the rotation axis 43 at each of upper and lower ends of the latch member 42, as is apparent from FIG. 4. The upper second specific portion 42c is opposed to the inner surface of the cover 14. The second specific portion 42c is located closest to the cover 14 in the latch member 42. The lower second specific portion 42c contacts with the base 13.

The second specific portions 42c may be made of an elastic resin material such as elastomer, rubber, or the like. The second specific portions 42c may be joined to the main portion 42a. Composite molding may be employed to form the main portion 42a and the second specific portions 42c in a one-piece structure. Alternatively, the second specific portions 42c may be made of a material having a property at least capable of transmitting an impact to the cover 14 and the base 13 by an intensity smaller than that of the main portion 42a. For example, the elastic modulus of the second specific portions 42c may be set smaller than that of the main portion 42a. The hardness of the second specific portion 42c may be set smaller than that of the main portion 42a.

Here, the repulsive coefficient established between the metallic piece 36 and the actuator stop member 37 is adjusted based on the repulsive coefficient established between the first specific portion 42b and the first latch stop member 47. The repulsive coefficient between the metallic piece 36 and the actuator stop member 37 is preferably set equal to the repulsive coefficient between the first specific portion 42b and the first latch stop member 47, for example. In this case, the first specific portion 42b may be subjected to adjustment of the hardness or/and the elastic modulus. In other words, the material of the first specific portion 42b may be selected to have an appropriate repulsive coefficient.

Now, assume that the magnetic recording disk or disks 16 stop rotating. The latch member 42 is positioned at the standby position. When the read/write operation has been completed, the voice coil motor 25 drives the carriage 18 in the normal direction D1 around the support shaft 21. The carriage arms 22 and the head suspensions 23 are driven outward the magnetic recording disk or disks 16. When the flying head sliders 24 get opposed to the landing zones or non-data zones outside the outermost recording tracks, the load tabs 29 contact with the ramps 33. A further swinging movement of the carriage arms 22 allows the load tabs 29 to climb up inclined surfaces defined on the ramps 33. The load tabs 29 get remoter from the corresponding surfaces of the magnetic recording disk or disks 16.

A further swinging movement of the carriage arms 22 in the normal direction D1 allows the load tabs 29 to slide on the ramps 33. When the load tabs 29 reach the farthest position from the magnetic recording disk or disks 16, the metallic piece 36 in the support body 26 is received on the actuator stop member 37. The load tabs 29 are received on the ramp member 31. The carriage 18 in this manner reaches the inoperative position. The magnetic recording disk or disks 14 then stop rotating. Since the load tabs 29 are reliably held on the ramp member 31, the flying head sliders 24 are prevented from contacting with the magnetic recording disk or disks 16 even without any airflow acting on the flying head sliders 24. The flying head sliders 24 are thus effectively prevented from any attachment to a lubricant agent covering over the surfaces of the magnetic recording disk or disks 16.

When the hard disk drive 11 receives instructions for the read/write operation, the magnetic recording disk or disks 16 first start rotating. The voice coil motor 25 drives the carriage 18 around the support shaft 21 in the reverse direction D2 after the rotation of the magnetic recording disk or disks 16 enter a steady condition. The carriage arms 22 and the head suspensions 23 are driven toward the rotation axis of the magnetic recording disk or disks 16. The load tabs 29 slide on the ramps 33. A further swinging movement of the carriage arms 22 allows the load tabs 29 to move down the inclined surfaces of the ramps 33.

The flying head sliders 24 get opposed to the corresponding surfaces of the magnetic recording disk or disks 16 during the downward movement of the load tabs 29. The flying head sliders 24 enjoy a lift based on an airflow generated along the corresponding surfaces of the rotating magnetic recording disk or disks 16. A further swinging movement of the carriage arms 22 in the reverse direction D2 then allows the load tabs 29 to get off from the ramp member 31. The steady rotation of the magnetic recording disk or disks 16 allows the flying head sliders 24 to keep flying above the corresponding surfaces of the rotating magnetic recording disk or disks 16 even without a support of the ramp member 31. The carriage 18 is in this manner allowed to swing along a predetermined movement path.

Next, assume that the hard disk drive 11 is switched off. As shown in FIG. 2, the magnetic attraction of the permanent magnet 35 keeps the metallic piece 36 in contact with the actuator stop member 37. The carriage 18 is held at the inoperative position. The magnetic attraction acts on the magnetic piece 49 on the latch member 42 from the yoke of the voice coil motor 25. The latch member 42 is thus held at the standby position.

Here, assume that an impact acts on the enclosure 12. The impact is transmitted to the metallic piece 36 through the actuator stop member 37. A driving force is generated to swing the carriage 18 in the reverse direction D2 around the support shaft 21. The carriage 18 is forced to swing around the support shaft 21 from the inoperative position in the reverse direction D2 against the magnetic attraction of the permanent magnet 35. The support body 26 swings around the support shaft 21. The load tabs 29 slide on the ramps 33 toward the corresponding surfaces of the magnetic recording disk or disks 16.

The impact is also transmitted to the first specific portion 42b of the latch member 42 through the first latch stop member 47. The latch member 42 swings around the rotation shaft 43 in the second direction SD against the magnetic attraction from the yoke of the voice coil motor 25. As shown in FIG. 5, the first swinging piece 44 enters the movement path of the protuberance 41. The second swinging piece 45 is received on the second latch stop member 48. The latch member 42 is in this manner positioned at the operative position. The latch member 42 allows the hook 46 to engage with the protuberance 41. The carriage 18 is restrained from swinging movement in the reverse direction D2. The load tabs 29 are thus prevented from movement toward the magnetic recording disk or disks 16. The load tabs 29 are held on the ramp member 31. The flying head sliders 24 are prevented from contacting with the magnetic recording disk or disks 16. The flying head sliders 24 are prevented from any attachment to the magnetic recording disk or disks 16.

The repulsive coefficient established between the carriage 18 and the actuator stop member 37 coincides with the repulsive coefficient established between the latch member 42 and the first latch stop member 47 in the hard disk drive 11. The identical condition can be established for transmission of an impact between the carriage 18 and the actuator stop member 37 as well as between the latch member 42 and the first latch stop member 47. The timing of the swinging movement of the carriage 18 coincides with the timing of the swinging movement of the latch member 42. In other words, the swinging movement of the carriage 18 can be synchronized with the swinging movement of the latch member 42. The latch member 42 is thus allowed to reliably engage with the carriage 18. The flying head sliders 24 are prevented from contacting with the magnetic recording disk or disks 16. The flying head sliders 24 are prevented from any attachment to the magnetic recording disk or disks 16.

Next, assume that an impact acts on the enclosure 12 in the axial direction of the rotation axis 43 during the rotation of the magnetic recording disk or disks 16. The latch member 42 moves upward and downward along the rotation axis 43. The latch member 42 allows the second specific portions 42c to collide against the cover 14 and the base 13, respectively. Since the second specific portions 42c are made of an elastic material such as rubber, the collision can be weakened between the latch member 42 and the cover 14 as well as between the latch member 42 and the base 13. Vibration is suppressed in the cover 14 and the base 13. Less vibration is transmitted to the carriage 18 through the screw 15 or the base 13. Moreover, the frequency can be lowered in the transmitted vibration. Resonance can thus be avoided between the vibration and signals supplied to the flying head sliders 24 and/or the voice coil motor 25, for example. The flying head sliders 24 can be positioned with a higher accuracy relative to the magnetic recording disk or disks 16.

The inventors have observed the effect of the aforementioned repulsive coefficients on a simulation on a computer. The inventors have prepared models corresponding to an embodiment of the present invention and a comparative example. In the embodiment, the repulsive coefficient, referred to “first repulsive coefficient” hereinafter, between the carriage 18 and the actuator stop member 37 is set to coincide with the repulsive coefficient, referred to “second repulsive coefficient” hereinafter, between the first specific portion 42b and the first latch stop member 47. Specifically, the first repulsive coefficient is set equal to the second repulsive coefficient. The first repulsive coefficient is set significantly different from the second repulsive coefficient in the comparative example.

Impacts were applied to the embodiment and the comparative example. The duration of the impacts was set at 0.4 [msec], 0.6 [msec] and 0.8 [msec]. The magnitude of the impact was set constant. The calculation was effected to reveal the angle [θ] of swinging movement of the carriage 18 for a unit time interval [msec] and the angle [θ] of swinging movement of the latch member 42 for a unit time interval [msec]. It should be noted that the swinging movement of the latch member 42 by nine degrees from the standby position allows the latch member 42 to reach the operative position. The swinging movement of the latch member 42 in a range between 2.5 degrees and 9.0 degrees allows the hook 46 on the first swinging piece 44 to stay within the movement path of the protuberance 41. If the hook 46 fails to exist within the movement path of the protuberance 41 at the moment when the carriage 18 has reached the angle of 2.5 degrees, the latch member 42 cannot engage with the carriage 18.

As shown in FIG. 6, a constant ratio was obtained between the rotation rate of the carriage 18 and the rotation rate of the latch member 42 for any duration of the impact in the embodiment The latch member 42 took the angle of 9 degrees at the moment when the carriage 18 had reached the angle of 2.5 degrees for any duration of the impact in the embodiment. It has been confirmed that the latch member 42 never fails to engage with the carriage 18 for any duration of the impact. The inventors have found advantages in adjustment of the repulsive coefficients in the manner as described above.

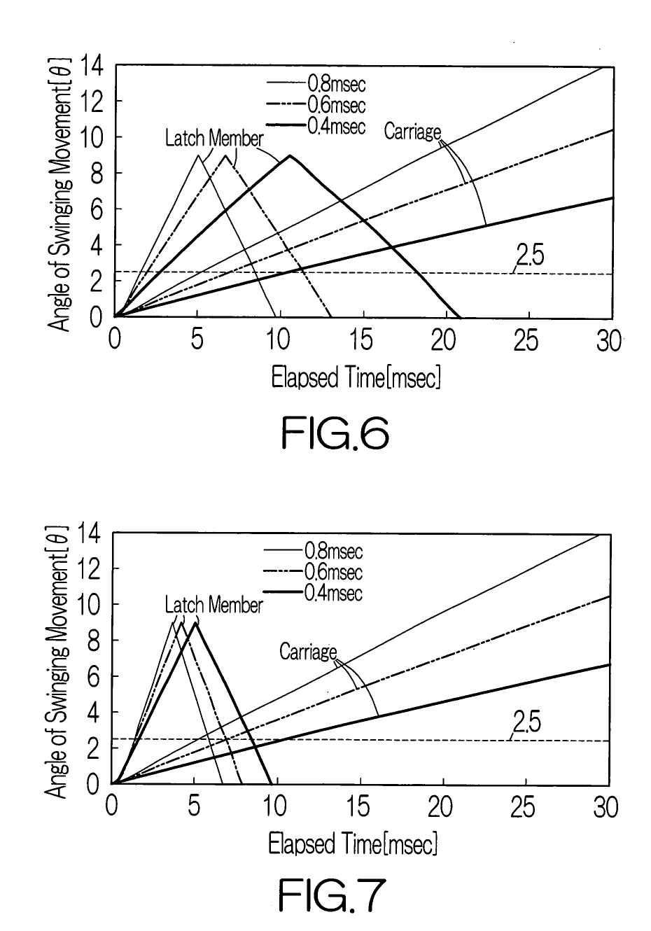

As shown in FIG. 7, a constant ratio could not be obtained between the rotation rate of the carriage 18 and the rotation rate of the latch member in the comparative example. If the duration of the impact was set shorter than 0.6 [msec] in the comparative example, the hook 46 of the latch member 42 was forced to deviate from the movement path of the protuberance 41, when the carriage 18 had reached the angle of 2.5 degrees. It has been confirmed that some duration of the impact allows the carriage 18 to pass by the latch member 42.

Next, the inventors have observed the effect of the second specific portions 42c. The inventors have prepared samples of a hard disk drive. The first and second specific portions 42b, 42c were omitted from the latch member 42 of the aforementioned hard disk drive 11 in the samples. The first sample included a latch member made of polyacetal (POM). The second sample included a latch member made of polyetherimide (PEI). Polyacetal has the hardness of M65 and the elastic modulus of 3,000 [MPa]. Polyetherimide has the hardness of M109 and the elastic modulus of 3,500 [MPa], both larger than those of polyacetal. Namely, polyetherimide is a material having a lower hardness and a lower elastic modulus to polyacetal.

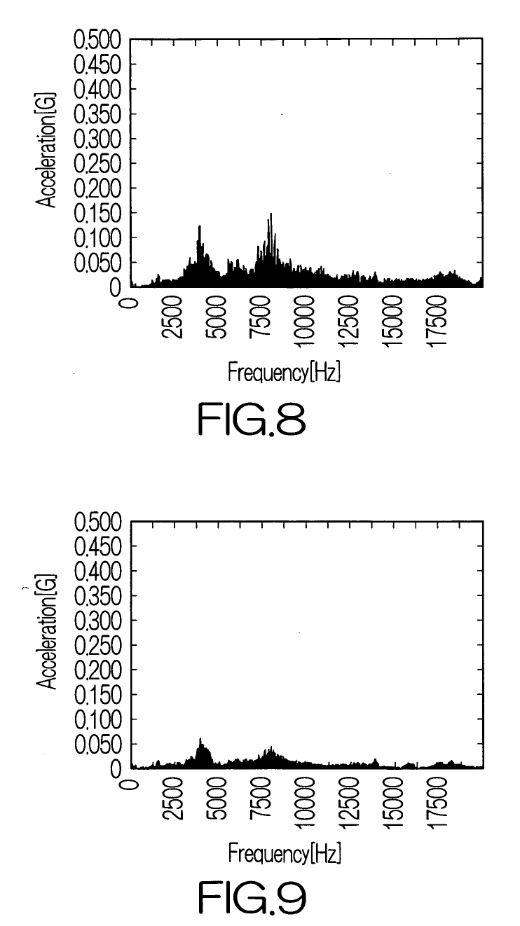

An acceleration sensor was attached to the cover of the samples. An impact was applied to the enclosure of the samples. The impact had the magnitude of 3[G]. The acceleration sensor was utilized for measurement of the acceleration of the cover in response to the impact. As shown in FIG. 8, a larger acceleration was observed in the second sample. As shown in FIG. 9, an acceleration significantly smaller than that of the second sample was observed in the first sample.

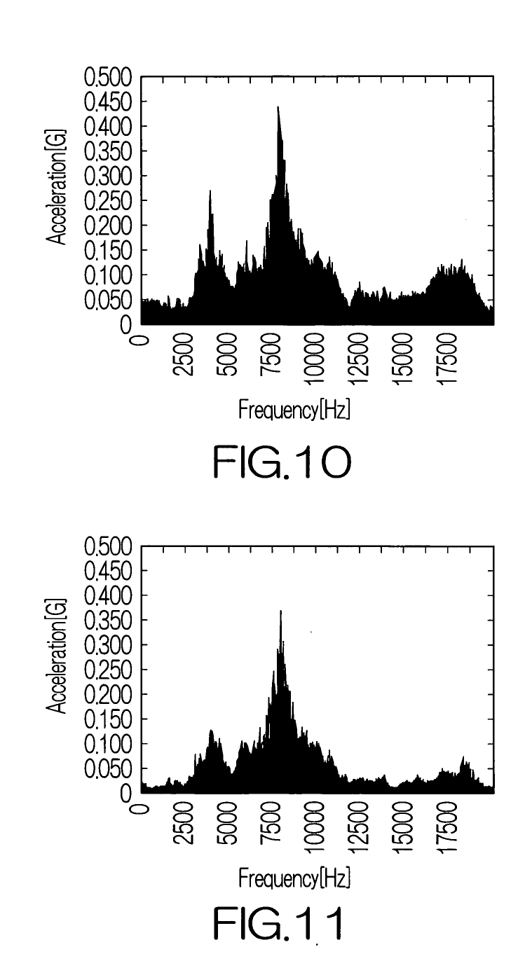

Next, the impact was set to have the magnitude of 5[G]. The acceleration sensor was likewise utilized for measurement of the acceleration of the cover. As shown in FIG. 10, a larger acceleration was observed in the second sample. As shown in FIG. 11, an acceleration significantly smaller than that of the second sample was observed in the first sample.

The inventors have demonstrated that a smaller hardness and a smaller elastic modulus lead to reduction in the vibration of the cover. If the hardness is set equal, a smaller elastic modulus of the latch member leads to reduction in the acceleration upon application of an impact. The latch member 42 thus should be made of a material having an elastic modulus as smaller as possible. Accordingly, the aforementioned second specific portion 42c is effective to reduce the vibration of the carriage 18 in response to the movement of the latch member 42 along the rotation shaft 43. One should take account of various property such as hardness, weight, and the like, of the material for the latch member 42 upon selection of the material for the latch member 42.

What is claimed is:

1. A recording medium drive comprising:
a head actuator member supported on a support shaft for swinging movement around the support shaft;
a latch member supported on a rotation shaft for swinging movement from a standby position around the rotation shaft, said latch member designed to engage with the head actuator member;
a latch stop member designed to receive the latch member at the standby position, wherein
the latch member has a portion allowed to contact with the latch stop member, said portion being made of a material different from a material of a main portion of the latch member.

2. The recording medium drive according to claim 1, further comprising an actuator stop member designed to receive the head actuator member positioned at an inoperative position, wherein
a repulsive coefficient obtained between the head actuator member and the actuator stop member coincides with a repulsive coefficient obtained between the portion and the latch stop member.

3. A recording medium drive comprising:
an enclosure;
a head actuator member supported on a support shaft in the enclosure for swinging movement around the support shaft; and
a latch member supported on a rotation shaft in the enclosure for swinging movement around the rotation shaft, said latch member designed to engage with the head actuator member, wherein
the latch member has a portion located near or in contact with an inner surface of the enclosure, said portion being made of a material different from a material of a main portion of the latch member.

4. The recording medium drive according to claim 3, wherein said portion is located around the rotation shaft at at least one of upper and lower ends of the latch member.

5. A latch member for a recording medium drive, designed to swing around a rotation shaft so as to engage with a head actuator member in an enclosure of the recording medium drive, said latch member having a portion located near or in contact with an inner surface of the enclosure, said portion being made of an elastic material.

6. A latch member for a recording medium drive, designed to swing around a rotation shaft so as to engage with a head actuator member in an enclosure of the recording medium drive, said latch member having a portion allowed to contact with a latch stop member when the latch member takes a standby position, said portion being made of a material different from a material of a main portion of the latch member.
